(19) United States
(12) Patent Application Publication
(10) Pub. No.: US 2003/0204611 A1
(43) Pub. Date: Oct. 30, 2003

(54) Communications tester and method of using same

(76) Inventors: John C. McCosh, San Diego, CA (US); Darrell J. Johnson, La Mesa, CA (US)

Correspondence Address: William J. Kolegraff, 3119 Turnberry Way, Jamul, CA, 91935, US

(21) Appl. No.: 10/134,417

(22) Filed: Apr. 29, 2002

(51) Int. Cl. G06F 15/16

(52) U.S. Cl. 709/230

(57) ABSTRACT

A portable and handheld communications tester is provided. The communications tester conveniently simulates a DHCP client for establishing communication with a DHCP server. Accordingly, the communications tester exchanges standardized DHCP messages with the server to be assigned a dynamic IP address. The communications tester thereby verifies operational connectivity with the DHCP server. The communications tester may be arranged with particular physical connectors for connecting to Ethernet, DSL, fiber optic, and/or coaxial cables. Further, the communications tester may have an optional integral modem for providing modulation and demodulation on the communication cable. In a particular example of the communications tester, the communications tester also incorporates a PING function for interrogating IP devices along the communication link. The tester may also employ BERT, Stress and other testing functions to further characterize and verify the robustness of the communication connection. Conveniently, the communications tester may be provided as a standalone device, or may be integrated into existing portable test equipment.

### BACKGROUND

The field of the present invention is portable testers for data communication devices. More particularly, the present device relates to testing communication devices enabling TCP/IP communication.

The widespread use of the Internet has lead to the wide deployment of network computer systems using TCP/IP protocol. In a typical network configuration, a client-computing device establishes communication with a computer server. Various hubs, routers, or switches may be interposed between the client computer and the server compute to assist in managing network data packets. Local network connections are often established through a LAN (local area network), with the LAN supporting an Ethernet communication standard. Ethernet is well known and has been adopted by the IEEE standards group as IEEE802.

In a particular configuration, the Ethernet standard uses a 10BaseT, 100BaseT or 1000BaseT connection and cabling. The Ethernet connection uses a twisted pair cable to interconnect network devices. Typically, the Ethernet cable is terminated with RJ-45 style connectors, although other connector types may be used. The RJ-45 connectors provide a simple and convenient way to make snap-style connections with the cables. 10BaseT operates to a maximum of 10 megabits per seconds, while 100BaseT operates up to 100 megabits per second. The newer gigabit Ethernet standard, 1000BaseT , operates at 1000 megabits per second, and other standards are under consideration by the standards body.

In a residential installation, a 10BaseT or 100BaseT cable may interconnect a client computer to a connection box at the exterior of the home. The connection box is where the service operator connects the operator-owned system to the customer cabling and devices. In an office environment, a 10BaseT, 100BaseT or 1000BaseT cable may interconnect client computing devices to a network closet where the cable terminates at a hub, router, or switch. The hub, router, or switch may then connect through other network devices to a server. For communication links needing more bandwidth than available on a 10BaseT or 100BaseT cable, higher bandwidth solutions may be used. For example, the backbone connection between major servers may be a SONET (Synchronous Optical NET) connection, a wideband coax cable, or a dedicated subscriber line such as a T1.

Internet connectivity may now be brought to customer facilities using a television coaxial cable, a DSL (digital subscriber line), a fiber optic cable, or a direct satellite link. Typically, a public carrier such as a cable operator or a phone company will own the communication link up to the customer premises. The customer then owns the cabling system inside the customer facility. The demarcation point between the operator owned communication link and the customer side wiring is at a connection box. A connection box facilitates the interface between the operator communication link and the customer wiring. Further, the connection box may be conveniently positioned to enable an installer or other operator to electrically test the connection from the connector box to the operator communication link. For example, a television cable generally is accessible at a connection box on the outside of an individual residence. By removing the cover on the box, an installer or other operator may place a power meter on a test point to verify that there is sufficient signal strength coming from the operator's transmission facility. In this regard, the operator may verify the performance of the operator communication link without accessing customer wiring.

If a user experiences difficulty receiving a signal at a device, such as a cable TV, the user may place a service call to the cable operator. The cable operator may therefore send a technician to the residence and test the signal strength at the connection box. If signal strength is sufficient at the connection box, then the cable operator has determined that the problem exists in the customer wiring and not in the operator side system. The cable operator may then receive an hourly fee from the customer for repairing the customer wiring or otherwise determining the specific problem on the customer side of the connection box. By verifying that the operator equipment and system is working properly, the operator is relieved of the repair responsibility. Without such an ability to easily and quickly determine if a fault lies with the operator equipment or within the customer premises, an operator can lose substantial time and money in troubleshooting. Test equipment for verifying the performance of operator TV cable and analog phone lines is well known. However, there exists a need for test equipment to assist in verifying operator network data equipment, such as servers, routers, and switches.

In setting up and configuring a TCP/IP network, an operator often installs a DHCP (dynamic host control protocol) system on its server or servers. The DHCP is a protocol for dynamically assigning IP addresses to devices on a network. With dynamic addressing, devices on a network can have different IP addresses every time they connect to the network. In some systems, the device's IP address can even change while in a single session. DHCP also supports a mix of static and dynamic IP addresses. Dynamic addressing simplifies network administration because the DHCP software keeps track of IP addresses rather than requiring an administrator to manage the task. This means that a computer may be added or removed from a network without manually assigning a unique IP address. Further, since the number of IP addresses may be limited, DHCP facilitates reuse of IP addresses.

DHCP is a popular configuration protocol having well-known message exchanges. In practice, most ISPs (Internet Service Providers) use DHCP for dynamically assigning IP addresses. Further, the same server that often hosts the DHCP software also acts as the primary server for the ISP. Accordingly, verifying communication with the DHCP server is also useful in verifying and characterizing connectivity of a client to the main server.

In a typical installation procedure, an installer visits a customer facility and verifies proper configuration at the connection box. For example, if an installer is installing a cable modem system for a customer having an existing cable TV connection, the installer would verify that sufficient signal strength is present at the connection box. However, the installer is not able to verify data connectivity back to the TCP/IP server, but is only able to verify the overall strength of the modulated signal transmitted on the cable. In order to verify data connectivity, the installer or the customer connects a modem to a cable outlet inside the client facility, and connects a computer to the modem. In this regard, the modem connects to the TV cable using standard coax connectors, while the computer typically connects to the modem with a 10baseT or 100baseT Ethernet cable using RJ-45 connectors. The client or the installer loads communication software onto the computer, and typically runs diagnostic programs.

The diagnostic programs often run two individual tests. First, the communication software may perform a DHCP configuration test. This test has the client device and the DHCP server exchange a series of DHCP messages. A proper exchange of DHCP messages results in the client computer being assigned a dynamic IP address by the operator's DHCP server. Second, the communication software may perform a PING test that exchanges messages with a device having a known IP address, such as a switch on the operator's network system. The PING function therebye establishes and verifies that basic TCP/IP communication is occurring. Additional data exchanges may occur to verify the robustness and speed of the connection, or otherwise characterize the network communication link. For example, the communication software may perform a bit error rate test (BERT) or a communication stress test. The stress test provides additional verification that the communication link is capable of handling the bandwidth required. Once the DHCP, PING, and additional tests have been successfully completed, the user or installer is confident the client computer is properly accessing the DHCP server, and therefore is in good operational condition.

However, such confirmation required the use of customer equipment and communication on customer wiring. In this regard, it is possible that a customer computer could fail to make connection to the DHCP server, but yet the DHCP server and all operator resources are operating properly. It may consume substantial time and money for the installer or operator to confirm that the problem is a customer side issue. Although the above example was made with reference to a cable modem connected to a TV cable, similar issues arise with DSL lines and direct satellite communication links.

In one known solution to the problem, an installer carries a portable computer to the customer facility. The installer thereby may connect the computer at the connection box directly to the operator/server communication link. In this regard, the installer may verify communication with network devices using diagnostic tools such as the PING and DHCP tests. However, carrying around a portable computer to perform such a test is highly inconvenient for the installer. A portable computer is somewhat fragile and susceptible to damage from elements or other environmental impacts. For example, it may be difficult for an installer to successfully connect a portable computer to a connection box while it is raining without damaging the computer. Not only is there risk of dropping and breaking the computer, but also the rain may permanently damage or destroy the portable computer. Further, it is difficult to hold and balance a bulky portable computer in the limited space available near many connection boxes. Personal computers are also expensive, and a desirable target for theft.

Accordingly, there exists a need for a test device that more conveniently enables verification of operator-side network communication without the use of customer devices or cabling.

### SUMMARY

Briefly, the present invention provides a portable, handheld communications tester. The communications tester conveniently simulates a DHCP client for establishing communication with a DHCP server. Accordingly, the communications tester exchanges standardized DHCP messages with the server to be assigned a dynamic IP address. The communications tester thereby verifies operational connectivity with the DHCP server. The communications tester may be arranged with particular physical connectors for connecting to Ethernet, DSL, fiber optic, and/or coaxial cables. Further, the communications tester may have an optional integral modem for providing modulation and demodulation on the communication cable. In a particular example of the communications tester, the communications tester also incorporates a PING function for interrogating IP devices along the communication link. The tester may also employ BERT, Stress and other testing functions to further characterize and verify the robustness of the communication connection. Conveniently, the communications tester may be provided as a standalone device, or may be integrated into existing portable test equipment.

Advantageously, the communications tester enables an installer or other operator to conveniently and efficiently verify DHCP conductivity with a server system without use of any customer devices or customer cabling. The communications tester may be constructed with a desirable form factor for portable and hand-held operation. Alternatively, the communications tester may be integrated into an existing and familiar portable test device, such as a telephone test set or a signal power meter.

### BRIEF DESCRIPTION OF THE DRAWINGS

FIG. 1 is a diagram showing a communications tester in accordance with the present invention;

FIG. 2 is a diagram of a test environment using the communications tester of FIG. 1;

FIG. 3 is a diagram of a test environment using the communications tester of FIG. 1;

FIG. 4 is a functional block diagram of a communications tester in accordance with the present invention;

FIGS. 5a, 5b, and 5c show test environments using communications testers in accordance with the present invention;

FIG. 6 is a telephone test set incorporating a communications tester in accordance with the present invention;

FIGS. 7a 7b, and 7c show a telephone test set in accordance with the present invention in a test environment; and

FIG. 8 is a block diagram of a communications tester in accordance with the present invention.

### DETAILED DESCRIPTION

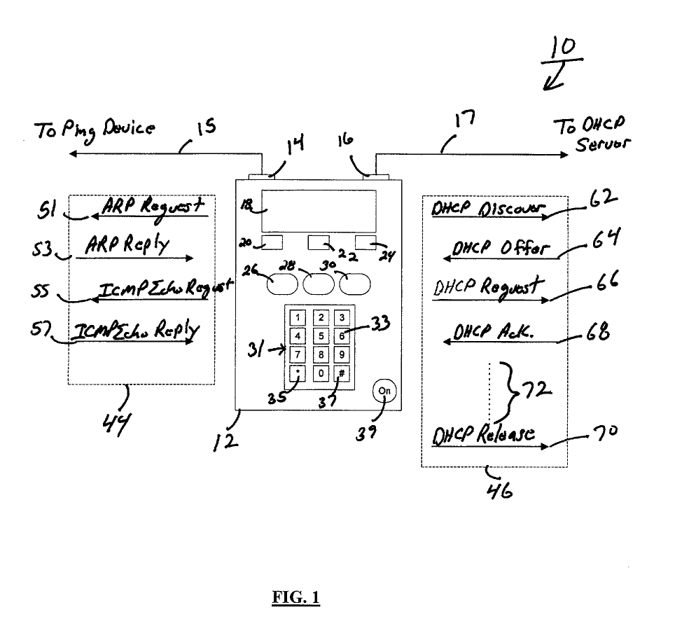

Referring now to FIG. 1, a communications tester 10 in accordance with the present invention is illustrated. Communications tester 10 generally comprises a housing 12 having a user display 18. The user display presents information to the user, and may include a soft key portion to indicate a current function for the each of the function keys 20, 22, and 24. A user further interacts with communications tester 10 using control keys 26, 28, and 30. Communications tester 10 also includes a numeric keypad 31 arranged as a standard telephone number pad. In this regard, keypad 31 contains numeric keys 33, a star key 35, and a pound key 37. Additionally, the communications tester 10 has a power key 39.

Communications tester 10 also has connectors for connecting to communication lines. For example, communications tester 10 is shown with connector 14 and connector 16. In a preferred embodiment, both connector 14 and connector 16 are constructed as RJ-45 connectors. Accordingly, connector 14 and connector 16 can make easy and convenient connection to 10BaseT, 100BaseT, and 1000BaseT Ethernet cables. It will be appreciated, however, that connector 14 and connector 16 may be alternatively configured to mate with different types of cables. For example, the connectors may be constructed to attach to a DSL cable, fiber optic cable, or to a coaxial cable.

Communications tester 10 is shown with connector 14 and connector 16, with connector 14 intended to couple to a client communication line 15, and with connector 16 intended to couple to a server communication line 17. It will be appreciated, however, that the communications tester 10 could be constructed with a single connector for connection to either a client communication line or to a server communication line. When connected as illustrated in FIG. 1, communications tester 10 enables a DHCP configuration exchange 46 with a DHCP server through connector 16, and enables a PING exchange 44 with a client device through connector 14.

During operation, the communications tester initiates the DHCP exchange 46 by sending a DHCP discover 62 packet to a DHCP server. If the DHCP discover packet 62 is successfully received by the DHCP server, then the DHCP server will respond with a DHCP offer packet 64. The DHCP offer packet 64 contains configuration parameters, IP address, subnet mask, gateway address if present, and the DHCP server IP address. Provided the communications tester 10 successfully receives the DHCP offer packet 64, the communications tester 10 responds with a DHCP request packet 66. The DHCP request packet 66 requests the offered DHCP configuration parameters. Provided the DHCP request packet 66 has been successfully received by the DHCP server, the DHCP server responds with a DHCP acknowledgement packet 68. The DHCP acknowledge packet 68 informs the communications tester 10 that the DHCP request has been granted.

At this point, the communications tester may exchange several data packets 72 with the DHCP server to characterize and further test the communication link with the DHCP server. For example, messages may be sent and timed to gauge throughput and efficiency of the communication connection. Such data exchanges 72 may continue as defined by the communications tester or as defined by a user of the communications tester 10. Once the data exchanges 72 are complete, the communications tester 10 sends a DHCP release packet 70 to the DHCP server. Upon receiving the DHCP release packet 70, the server unassigns the IP address to the communications tester and that IP address may become available for the DHCP server to assign to another device.

The DHCP exchange 46 enables the communications tester 10 to verify operable conductivity with the DHCP server. Importantly, such verification is achieved without use of any customer side wiring or customer equipment. However, the communications tester may be used to verify certain performance in customer side wiring and customer equipment. For example, customer communication line 15 may be connected to a router within the customer facility. The communications tester 10 may perform a PING function with the router to verify conductivity and addressing for the router.

The PING exchange 44 comprises the communications tester 10 sending an ARP (address resolution protocol) request packet 51 to the Ethernet Broadcast MAC address, which all devices on the network listen for. The ARP Request packet requests the MAC (Media Access Controller) hardware address of the device presently assigned to a specific I.P. (Internet Protocol) address. The device, if properly connected, will respond to the ARP request 51 by transmitting an ARP reply packet 53 back to the communications tester 10. The ARP reply packet 53 contains the MAC address of the device. Using the MAC address for the device, the communications tester 10 then sends an ICMP (internet control message protocol) echo request packet 55 to the device. The echo request packet 55 requests that the device retransmit the packet back to the communications tester 10.

The device then responds to the ICMP echo request 55 by transmitting an ICMP echo reply packet 57. The echo reply packet 57 is intended to contain the same data as was transmitted in the echo request packet 55. The communications tester 10 compares the data received in the echo reply packet 57 to the data transmitted in the echo request packet 55. If the received data matches the transmitted data, the display 18 is updated to indicate proper communication. The communications tester 10 also may measure the time delay between the transmission of the echo request packet 55 and the reception of the echo reply packet 57 and display the round trip time, thereby indicating an efficiency and speed of the network. Although the PING exchange 44 has been generally described, it will be appreciated that modification may be made to the PING exchange to satisfy particular network administration needs. It will also be appreciated that although the PING exchange 44 has been shown as occurring on the client communication line 15, that the PING exchange could also be performed on the server communication line 17, and could be directed through either connector 14 or connector 16.

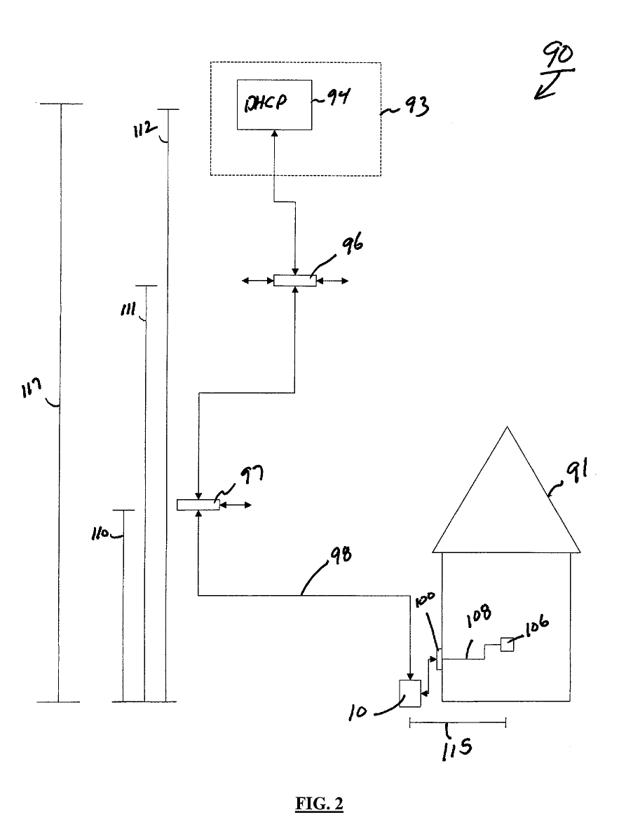

Referring now to FIG. 2, a test environment 90 is illustrated. Test environment 90 has a communications tester 10 in use at the exterior of a customer premises 91. A server link 98 couples to the customer premises 91 through a connector box 100. When in use, the communications tester is connected to server link 98 and also may be connected to the data cable 108 inside the customer premises. In this regard, the communications tester may test both the server connection and may test and verify wiring and devices inside the customer premises 91. The network service provider has a provider office 93 having a DHCP server 94. The DHCP server 94 communicates to the customer premises 91 through various switches and routers, such as switch and routers 96 and 97. Additionally, the DHCP server 94 may communicate through other servers on to the server link 98.

In use, the communications tester is coupled to the server link 98, and a DHCP message exchange initiated. In this regard, the communications tester 10 requests and is assigned an IP address from the DHCP server. Additional tests and data exchanges may occur to further verify and characterize the communication link. Upon successful completion of the DHCP test, the communications tester may release its lease on the IP address so the DHCP server 94 can use that IP address for another device. Further, communications tester 10 may use its integral PING function to PING routers, servers or other devices along the server communication path. For example, a PING exchange 110 may occur between the communications tester 10 and router or switch 97. In a similar manner, a PING exchange 112 may occur between the communications tester and the router or switch 96, and also a PING function may be established between the communications tester 10 and a server such as the DHCP server 94. Accordingly, the communications tester 10 can perform sophisticated operational tests on the communication link through an operator's server network. This can be accomplished without use of any client equipment or customer wiring.

The communications tester 10 also may be connected to the data cable within the customer premises 91. Such a connection may allow the communications tester to PING coupled customer equipment, such as computer 106. In this regard, the communications tester 10 provides a customer side PING exchange 115 with computer 106.

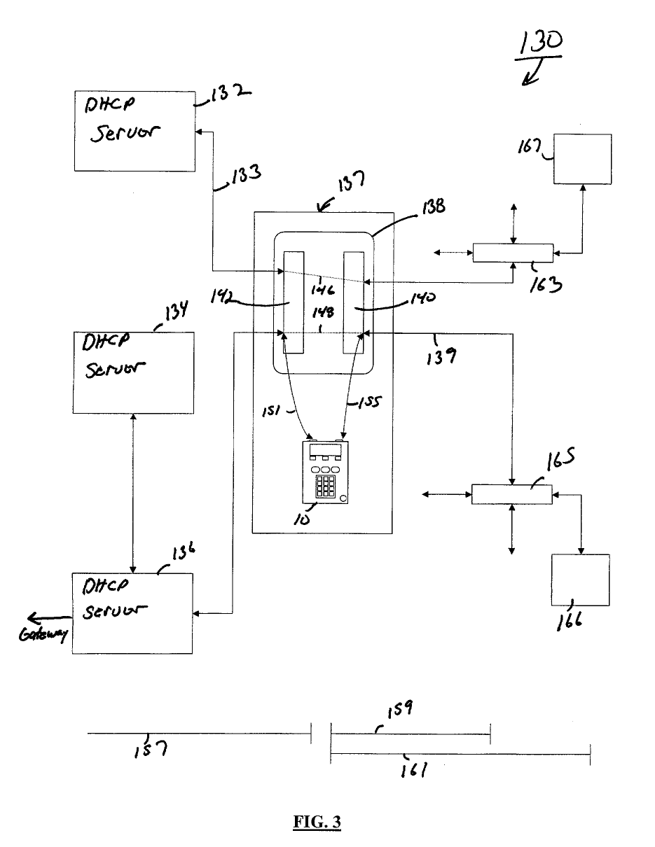

Referring now to FIG. 3, communications tester 10 is shown in a different test environment 130. Test environment 130 is a business environment having a network closet 137 and a patch panel 138. The patch panel 138 provides a server patch area 142 that connects to servers, such as DHCP server 132. It is also likely that multiple servers may be available in the system such that the server patch area 142 also couples to other servers, such as DHCP servers 134 and 136. The patch panel 138 enables a network administrator to make physical connections between servers and client equipment. In this regard, patch cords 146 and 148 make connections between servers and client equipment. For example, patch cord 146 connects DHCP server 132 to client communication link 139. Client communication link 139 is connected to router 163 and computer 167. In a similar manner patch cord 148 connects DHCP server 136 to router 165 and computer 166.

When troubleshooting a network, it will be highly desirable for an operator to attach the communications tester 10 to the server communication lines using server connection 151. When connected, the communications tester 10 is enabled to perform a DHCP exchange 157 with DHCP server 136. It is possible that a network has multiple DHCP servers, such as DHCP servers 134 and 136. Accordingly, communications tester 10 can be configured to automatically select a particular DHCP server, or may allow a user to select which DHCP server to consummate an IP address licensing arrangement.

Once the technician has confirmed that the server side of the patch panel 138 is working properly, the network technician can use communications tester 10 to perform PING tests on client side devices. For example, the communications tester 10 may be connected to client communication lines through client connector 155. In this regard, the communications tester 10 may perform a PING exchange 159 with router 165, or may perform a PING exchange 161 with computer 166. Accordingly, in an efficient manner a network technician can troubleshoot to determine operational conductivity on both the server side and the client side in a network.

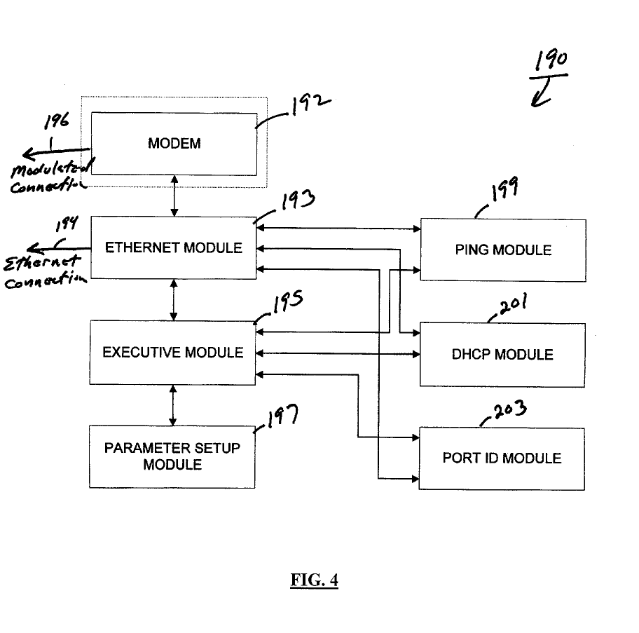

Referring now to FIG. 4 a block diagram 190 of a communications tester is described. Block diagram 190 indicates that a communications tester has an executive module 195. The executive module operates in the background and monitors for user input from the keypad, function keys, and control keys. The executive module also operates outputs such as the display, LED indicator, and any speaker. Further, the executive module 195 performs timing and analysis function in support of DHCP exchanges and PING exchanges, and generally monitors and schedules events within the communications tester, the executive module may also be used to generate and compare data exchanged in Ethernet data packets.

The parameter module 197 cooperates with the executive module 195 to enable the user to input or select a set of parameters. For example, a user may input or select a particular IP address for use with the PING function. In this way, a user may instruct the communications tester to PING a particular network device. The parameter module 197 may also have permanently stored parameters such as the MAC (media access controller) address for the communications tester.

The Ethernet module 193 also cooperates with the executive module and contains the routines require to operate the Ethernet interface hardware for sending and receiving data packets. The executive module 195 also interfaces with a port id module 203 to perform a particular test function where the communications tester sends an identifiable blink pattern to a hub, switch, or network interface card connected to the communications tester. In this regard, the port id module supports multiple link patterns to ensure compatibility and identifyability with a wide range of products. The port id module 302 facilitates identifying a particular physical cable connection port at a network device by providing an identifiable blink pattern at the connection point.

The PING module 199 cooperates with the executive module 195 to command the Ethernet module 193 to transmit and receive packets required to PING a specific IP address. As previously described, the PING function consists of a four-packet exchange between the communications tester and the device being PINGed.

The DHCP module 201 also operates in cooperation with the executive module 195 and the Ethernet module 193 to transmit and receive the packets from the DHCP server necessary to perform a DHCP exchange. If successful, the DHCP exchange results in the DHCP server temporarily leasing an IP address to the communications tester for a specific length of time. At the end of the lease time, or upon express release by the communications tester, the temporary IP address is relinquished and becomes available for the DHCP server to reassign. In use, the DHCP exchange generates certain network configuration parameters, such as IP address, gateway IP address, subnet mask, and DHCP server address that are accepted by the communications tester and used in the parameter setup module 197. After release of the IP address, the parameter setup module may resort to default configurations, or may require the user to identify and input additional information.

Optionally, the communications tester may contain a modem 192. Modem 192 accepts data packets from Ethernet module 193 and modulates the packets onto a particular communication transport via modulated connector 196. For example, modem 192 may accept Ethernet packets from Ethernet module 193 and modulate them for communication on a coaxial cable for a TV cable operator. In a similar manner, the modem may accept communications from the modular connector 196 and demodulate the signal to provide data packets to the Ethernet module 193. In this regard, the communications tester may be constructed to couple directly to various cable and protocol topologies.

In an example of a communications tester, the modules in FIG. 4 operate in cooperation with a processor, such as microcomputer or other micro controller. The processor may monitor and control the functionality of the communications tester, as well as providing for input and output to a user. The processor may also cooperate with other circuitry, such as a standard Ethernet MAC/PHY circuit for facilitating connection to the Ethernet. Further, the processor may incorporate additional standard or user defined communications tests for more complete characterization and verification of the communication connection. Such tests can be, for example, a BERT, communications stress test, or other such communication test.

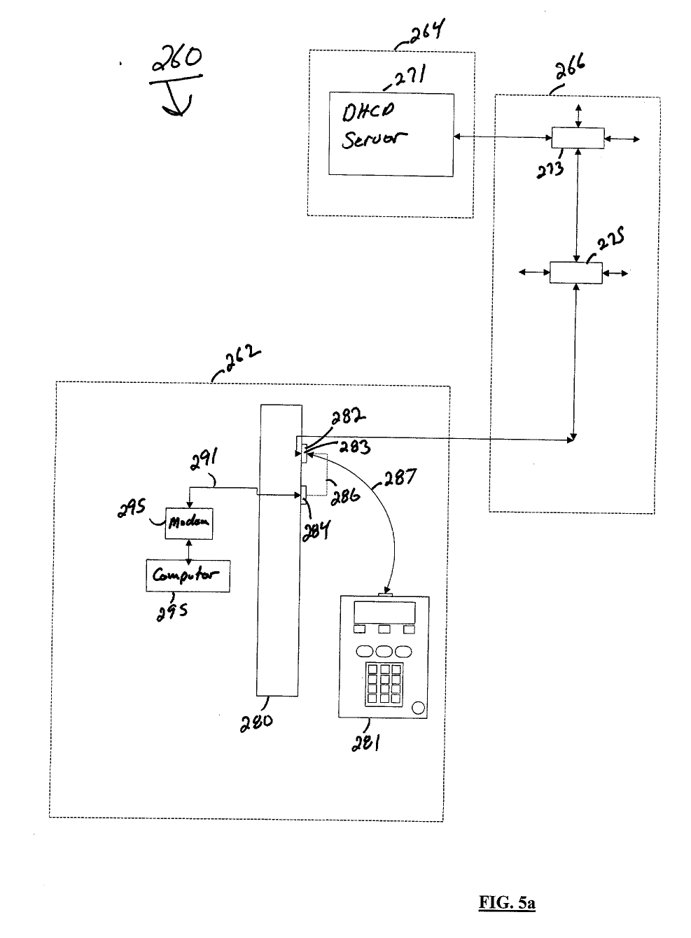

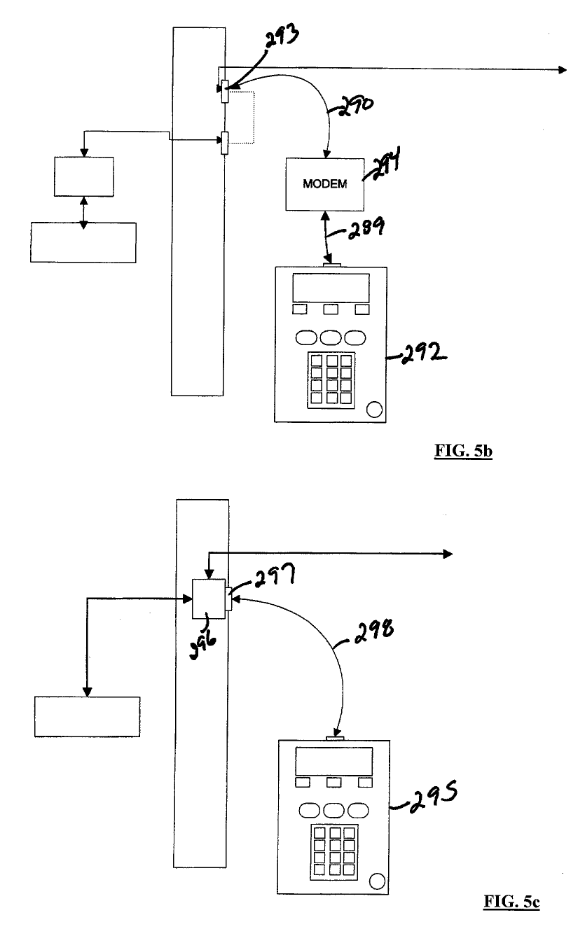

Referring now to FIG. 5a, another test environment 260 in accordance with the present invention is illustrated. Test environment 260 includes a service facility 264 having a DHCP server 271. A server communication link 266 connects the DHCP server 271 to the customer facility 262. More specifically, the server communication link 266 includes various routers and switches, such as router 273 and router 275. It will be appreciated that the server communication link may include several other components, including other additional routers, switches, and servers. The service communication link 266 interfaces with the customer facility 262 at a server port 282. The server port 282 is typically arranged in a customer connection box 280. The customer connection box 280 may be, for example, affixed to the outside of a residence or office building. The customer communication link 291, which is in the customer facility, connects from the customer connection box 280 to a modem 295. The modem 295 interfaces with a computer 296.

When the DHCP server 271 is in communication with the computer 296, a connector 286 connects the server port 282 to the client port 284. For test purposes, however, the connector 286 may be removed. In the example illustrated in FIG. 5a, the server communication link 266 connects to the customer connection box 280 using a modulated signal, for example a coaxial cable having a transmit signal. In this regard, the modulated signal is transmitted to the modem 295 where the signal is demodulated for communication with the computer 296. The link between the modem 295 and the computer 296 may be for example a 10BaseT, 100BaseT, or 1000BaseT Ethernet cable.

When a cable company receives an order to install a data service to the customer facility 262, a network technician approaches and opens the customer connection box 280. The technician may check the signal strength available on the server communication link using, for example, an RF power meter. Some arrangement of customer boxes may have a test port 283 to facilitate ease of connection of test equipment. Other connection boxes may require the technician to physically re-cable connector 286 or the line coming in from the server communication link 266. If sufficient signal strength is found, the communications tester 281 is connected to the server communication link 266 via tester cable 287. Preferably, tester cable 287 couples directly to test port 283. Communications tester 281 thereby is coupled to the server communication link 266.

The technician uses the keypad, control keys, and function keys to direct the communications tester 281 to perform one or more communication tests. For example, the technician may instruct the communications tester 281 to perform a DHCP exchange. In this regard, the communications tester 281 generates a DHCP discover packet, and an internal modem modulates the packet onto the tester cable 287 for insertion into the communication link 266. At the DHCP server side 271, a modem demodulates the DHCP discover packet and presents the packet to the DHCP server. In response, the DHCP server sends out a DHCP offer. The DHCP offer is communicated to the server modem and modulated onto the server communication link 266. The modulated signal is received at the communications tester 281, where it is demodulated and used. For example, if the communications tester desires to receive an IP address from the DHCP server 271, then the communications tester responds with a DHCP request packet following the procedures outlined above, and then the DHCP server will respond with a DHCP acknowledge as described above. The communications tester 281 has now been leased an IP address by the DHCP server, and may be used by the technician to perform additional communication tests to assure robustness and characterize operational communication. When sufficient tests have been performed, the communications tester 281 may be instructed to send a DHCP release packet to the DHCP server 271, thereby allowing the IP address to be released and reassigned to another user. Alternatively, the communications tester 281 does not need to send the DHCP release command, and the lease will naturally expire after a predetermined time.

The technician may perform further tests, such as a PING test. In this regard, the communications tester may be configured to have a PING exchange with one or more of the network devices on the server communication link 266 or even back to the DHCP server itself. Such additional testing can be useful for characterizing and validating network communication. Additionally, the network technician may remove the tester cable 287 from the test port 283 and connect it to the client port 284. In this regard, the communications tester 281 may now be used to perform basic communication tests with the computer 295. More specifically, the communications tester 281 may be used to perform a PING function with the modem 295 and the computer 296.

Advantageously, the network technician is able to verify network performance without use of any customer equipment or wiring. Further, from a single customer connection box, the technician is able to troubleshoot, verify, and characterize both server side communication and customer side communication.

Although communications tester 281 is shown as a stand-alone communications tester, it will be appreciated that the communications tester 281 may be incorporated into other test equipment. For example, the cable technician may already carry a power meter, and the communications tester 281 could be integrated into the power meter. Accordingly, the number of pieces of test gear that a technician must carry and learn how to operate is minimized.

Referring now to FIG. 5b a modification of test environment 260 is illustrated. In FIG. 5b, communications tester 292 is similar to communications tester 281, except that communications tester 292 does not have an internal modem. In this regard, the signal on cable 289 is compatible with 10BaseT, 100BaseT, or 1000BaseT Ethernet. Further, the connectors for cable 289 are typically RJ-45 standard connectors. As shown in FIG. 5b, the communications tester 292 connects to a modem 294 via cable 289. The modem 294 thereby performs the modulating and demodulating functions that were internal to the communications tester 281. In this regard the modem 294 connects to the test point 293 via cable 290. Although the modem 294 is shown as a separate device, it will be appreciated that the modem may actually couple to the communications tester 292 to minimize discreet components. Further, it will be appreciated that the modem 294 and communications tester 292 may communicate wirelessly, for example using a bluetooth standard.

FIG. 5c shows another alternative to test environment 260. In the communications tester 295 shown in FIG. 5c, the communications tester 295 again does not contain an internal modem. Cable 298 is compatible with a 10BaseT, 100BaseT, or 100BaseT Ethernet connection, with associated RJ-45 connectors. In this regard, cable 298 typically connects to test point 297 via an RJ-45 connector. The connector box contains additional circuitry 296 for providing modem capabilities, including modulation and demodulation.

Although FIG. 5a, 5b, and 5c are illustrated with the server communication link via a coaxial cable provided by a cable service operator, it will be appreciated that other communication links are contemplated within this disclosure. For example, communication link can be established using a DSL line, or using a direct link satellite receiver. Additionally, businesses may have an optical SONET link to their facility. In this case, the communications tester 292 may include either an internal optical converter, or may couple to an external optical coupler. Either way, the communications tester would be able to insert and extract data packets from the optical net.

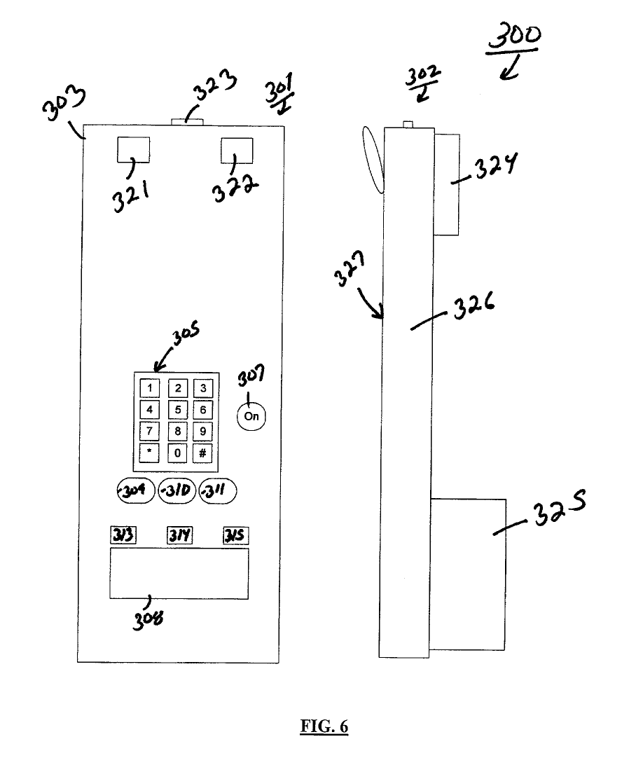

As previously described, the communications tester contemplated in this disclosure may be arranged or integrated with other known test equipment. For example, FIG. 6 shows a communications tester integral to a phone test set. The phone test set, commonly referred to as a butt set, generally appears as an oversized telephone hand set. More specifically, FIG. 6 shows tester 300 having a front view 301 and a side view 302. Side view 302 shows the general shape of the hand set 326 with an earpiece 324 and a mouthpiece 325. The front 327 of the handset includes a user interface and connectors for the technician. More specifically, the front 327 contains a full telephone style keypad 305 and a power switch 307. Further, the front 327 includes interface elements specifically for implementing the communications tester. For example, display 308, function keys 313, 314 and 315, and control keys 309, 310, 311 are all similar to the display, function keys, and control keys described in relation to other communications testers.

The tester 300 also has various network connectors on the housing 303. For example, telephone connector 323 allows the tester 300 to connect to a standard analog telephone system as is well known with butt sets. However, the housing 303 also includes connectors 321 and 322 for connecting the communications tester to a server communication link or a client communication link as previously described with other communications testers. Accordingly, connectors 321 and 322 could be RJ-45 connectors or alternatively, could be coaxial cable connectors. It will also be appreciated that connector 323 may be constructed digitally for interface to a digital subscriber line or other digital telephone system. Advantageously, the tester 300 provides a technician with a portable and well-known form factor for a test tool. Further the test set has increased utility as the tester 300 not only provides expected test capability, but also further includes DHCP exchange capability, and possibly PING capability. Additionally, test 300 may be configured to perform additional communications test, such as BERT and a stress test. These tests are useful for more fully characterizing and verifying the robustness of the communication connection. It will be appreciated that other communications tests may be used for particular applications and cabling systems.

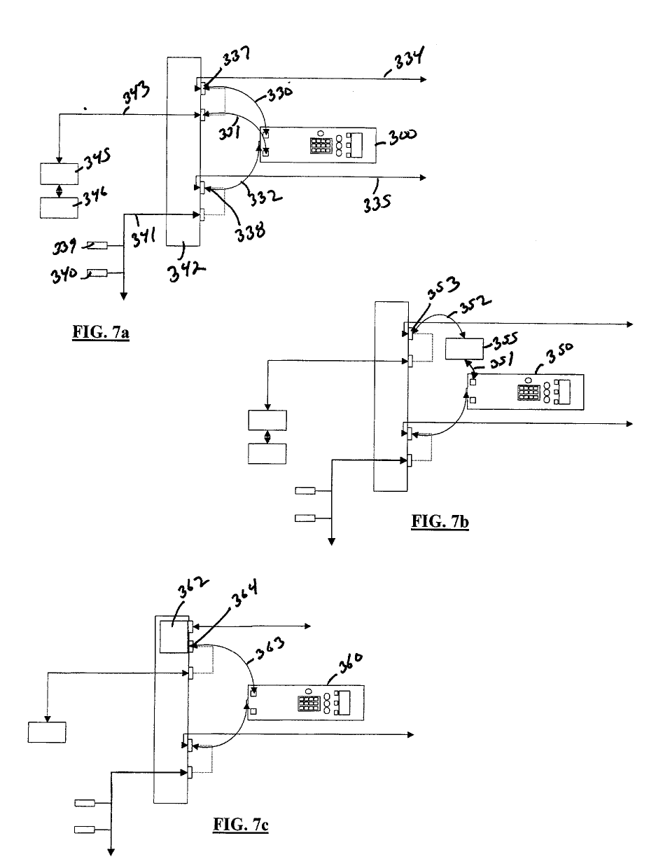

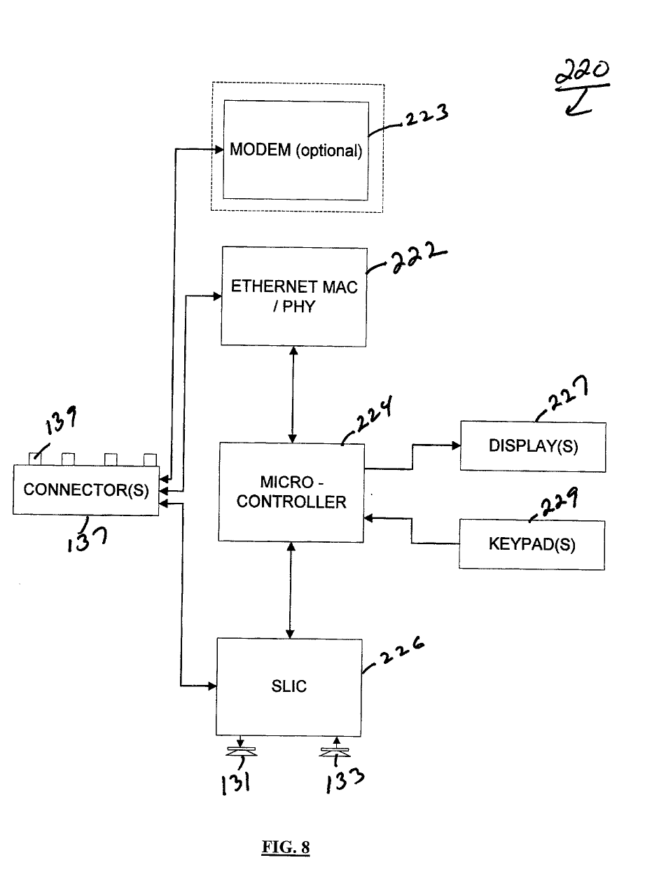

FIG. 7a shows tester 300 positioned at a customer connection box 342. Customer connection box 342 has a standard analog telephone communication link 335 and a server side communication link 334. The telephone communication link 335 couples to the connector box and has a telephone test point 338. The telephone connector on tester 300 is connected to the telephone test point 338 via telephone connector 332. When connected, the technician then can verify telephone communication link 335 using standard butt set techniques. In verifying the telephone communication link 335, the technician does not need to rely on any of the customer wiring 341 or use the customer telephones such as telephone 339 or 340.

The server site communication link 334 connects into connector box 342 and provides test point 337. As previously described, connector 330 connects from the test point 337 to the tester 300, while connector 331 connects to the client cable 343. Client cable 343 is connected to a modem 345 and a computer 346. In this configuration, the network technician can perform DHCP, PING, BERT, and/or stress tests on the server side communication link, without regard to customer cable 343 or other customer equipment. Additionally, the technician may perform PING functions through customer cable 343 to the modem 345 or computer 346. Tester 300 has an integral modem for modulating and demodulating packets onto connector 330. The modem may provide, for example modulation onto a coaxial cable provided by a cable service operator, or may provide modulation onto another communication link, such as an optical SONET link or a DSL line.

FIG. 7b shows a test environment similar to that of FIG. 7a, except tester 350 does not have an integral modem as did tester 300. Tester 350 communicates via cable 351 to modem 355. Modem 355 thereby provides the modulation and demodulation capabilities necessary to insert and extract the Ethernet packets on the server communication links. In this regard, the connection between modem 355 and the test point 353 may be for example a coaxial cable 352.

FIG. 7c shows another alternative of the test environment of FIG. 7a. Here the connector box contains additional circuitry necessary for doing a modulation and demodulation function. In this regard, the modem 362 provides a digital test point 364 for communication with the tester 360. Accordingly, tester 360 connects to the test point 364 with a 10BaseT, 100BaseT, or 1000BaseT Ethernet cable 363, and therefore does not use an internal modem for this connection.

Referring now to FIG. 8 a block diagram of a tester, such as tester 300, is shown. The bock diagram 220 indicates a micro controller 224 that monitors and controls functions for the tester. The micro controller operates all displays, such as the alpha numeric display and any LEDs. The micro controller accepts input from keypads, such as a numeric keypad, control keys, and function keys. The micro controller interfaces with an Ethernet MAC/PHY circuit 222. MAC/PHY circuits provide for the physical layer connection and media access control for Ethernet connectivity, and are readily commercially available. The MAC/PHY circuitry provides Ethernet conductivity through connectors 137. The micro controller 224 also controls an SLIC 226. The SLIC (subscriber line interface circuit) is a standard, well known circuit for providing analog telephone test capability. The SLIC then couples to connector 137 to be interfaced with analog telephone test points.

Optionally, block diagram 220 includes a modem 223. Modem 223 is under the control of the micro controller 224 and accepts data packets from the Ethernet MAC/PHY 222. The modem provides modulation and demodulation functions when a direct 10BaseT, 100BaseT, or 1000BaseT connection is not appropriate. Connectors 137 may include RJ-45 connectors 139, coaxial cable connectors, DSL connectors, and even fiber optic connectors.

While particular preferred and alternative embodiments of the present intention have been disclosed, it will be appreciated that many various modifications and extensions of the above described technology may be implemented using the teaching of this invention. All such modifications and extensions are intended to be included within the true spirit and scope of the appended claims.

What is claimed is:

1. A communications tester, comprising:
a portable and handheld housing;
a connector on the housing for coupling to a server-side communication line;
an Ethernet module for sending and receiving Ethernet packets, the Ethernet module constructed to send and receive Ethernet messages via the server-side communication line; and
a DHCP module cooperating with the Ethernet module and constructed to send and receive data packets to engage a DHCP exchange with a DHCP server.

2. The communications tester according to claim 1, further including a PING module cooperating with the Ethernet module and constructed to send and receive data packets to engage a PING exchange with a communication device coupled to the server-side communication line.

3. The communications tester according to claim 1, further including an executive module configured to control the operation of the communications tester.

4. The communications tester according to claim 1, further including a module cooperating with the Ethernet module and constructed to send and receive data packets to engage a bit error rate test (BERT) exchange with a communication device coupled to the server-side communication line.

5. The communications tester according to claim 1, further including a module cooperating with the Ethernet module and constructed to send and receive data packets to engage a communication stress test exchange with a communication device coupled to the server-side communication line.

6. The communications tester according to claim 1, further including a modem cooperating with the Ethernet module to modulate and demodulate Ethernet packets on the server-side communication line.

7. The communications tester according to claim 1, further including a Subscriber Line Interface Circuit (SLIC) and a SLIC connector on the housing, the SLIC constructed to perform testing of a operator-side analog telephone connection.

8. The communications tester according to claim 1, further including a Radio Frequency (RF) power meter and a coaxial connector on the housing, the RF Power meter constructed to perform RF signal strength testing of a operator-side cable connection.

9. The communications tester according to claim 1, where the connector is constructed as an RJ-45 Ethernet connector, for connection to a server-side Ethernet communication line.

10. The communications tester according to claim 1, where the connector is constructed as a coaxial connector, for coupling to a server-side coaxial cable.

11. The communications tester according to claim 1, where the connector is constructed as a fiber optic connector, for coupling to a server-side fiber optic cable.

12. The communications tester according to claim 1, where the connector is constructed to also couple to a client-side communications line.

13. The communications server according to claim 1, further including a second connector constructed to couple to a client-side communications line.

14. The communications tester according to claim 13, further including a PING module cooperating with the Ethernet module and constructed to send and receive data packets to engage a PING exchange with a communication device coupled to the client-side communication line.

15. A butt set, comprising:
a portable handset having a microphone and earpiece:
a Subscriber Line Interface Circuit (SLIC) and a SLIC connector on the housing, the SLIC constructed to perform testing of a operator-side analog telephone connection;
a connector on the housing for coupling to a server-side data communication line;
an Ethernet module for sending and receiving Ethernet packets, the Ethernet module constructed to send and receive Ethernet messages via the server-side data communication line; and
a DHCP module cooperating with the Ethernet module and constructed to send and receive data packets to engage a DHCP exchange with a DHCP server.

16. The butt set according to claim 15, further including a PING module cooperating with the Ethernet module and constructed to send and receive data packets to engage a PING exchange with a communication device coupled to the server-side data communication line.

17. The butt set according to claim 15, further including an executive module configured to control the operation of the communications tester.

18. The butt set according to claim 15, further including a module cooperating with the Ethernet module and constructed to send and receive data packets to engage a bit error rate test (BERT) exchange with a communication device coupled to the server-side data communication line.

19. The butt set according to claim 15, further including a module cooperating with the Ethernet module and constructed to send and receive data packets to engage a communication stress test exchange with a communication device coupled to the server-side data communication line.

20. The butt set according to claim 1, further including a modem cooperating with the Ethernet module to modulate and demodulate Ethernet packets on the server-side data communication line.

21. A method for verifying and characterizing a server-side data communication line, comprising:
accessing a connection box having a port to a server-side communication line;
connecting a portable tester to the port; and
performing a DHCP exchange with a DHCP server.

22. The method according to claim 21, further comprising the step of performing a PING exchange with a device on the server-side communication line.

23. The method according to claim 21, further comprising the step of connecting the communications tester to an analog telephone test port and performing an analog test verification on an operator-side telephone connection.
